(19) United States
(12) Patent Application Publication
(10) Pub. No.: US 2008/0022885 A1
(43) Pub. Date: Jan. 31, 2008

(54) Inks for display device manufacturing and methods of manufacturing and using the same

(75) Inventor: Lizhong Sun, San Jose, CA (US)

Correspondence Address: DUGAN & DUGAN, PC, 245 Saw Mill River Road, Suite 309, Hawthorne, NY, 10532, US

(73) Assignee: Applied Materials, Inc., Santa Clara, CA (US)

(21) Appl. No.: 11/494,286

(22) Filed: Jul. 27, 2006

(51) Int. Cl. C09K 3/18

(52) U.S. Cl. 106/13; 8/554

(57) ABSTRACT

An ink composition is provided for display device manufacturing via ink jetting. The ink includes (1) a first solvent having a first evaporation rate of about 0 to about 0.353; and (2) a second solvent having a second, different evaporation rate of about 0 to about 0.353 combined with the first solvent. Numerous other aspects are provided.

### CROSS-REFERENCE TO RELATED APPLICATIONS

The present application is related to the following commonly-assigned, co-pending U.S. patent applications, each of which is hereby incorporated herein by reference in its entirety for all purposes:

U.S. patent application Ser. No. 11/182,501, filed Jul. 15, 2005 and entitled “A RED PRINTING INK FOR COLOR FILTER APPLICATIONS” (Attorney Docket No. 10140);

U.S. patent application Ser. No. 11/183,188, filed Jul. 15, 2005 and entitled “A GREEN PRINTING INK FOR COLOR FILTER APPLICATIONS” (Attorney Docket No. 10141);

U.S. patent application Ser. No. 11/182,491, filed Jul. 15, 2005 and entitled “A BLUE PRINTING INK FOR COLOR FILTER APPLICATIONS” (Attorney Docket No. 10142); and

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” (Attorney Docket No. 9521/L).

### FIELD OF THE INVENTION

The present invention relates generally to inkjet printing systems employed during flat panel display formation, and is more particularly concerned with inks for display device manufacturing and methods of manufacturing and using the same.

### BACKGROUND

Methods of using inkjet systems that reduce the cost of manufacturing color filters have recently been developed. An inkjet system may be used to deposit different colors through different nozzles into sub-pixels formed by a patterned black matrix on a substrate. However, due in part to the small size of the pixel wells, the level of precision required is significant. Further, to manufacture color filters cost effectively, the ink must be deposited accurately and reliably. Thus, what is needed are systems, methods, and compositions for depositing ink into color filter pixel wells accurately and reliably.

Further, the development of inkjet systems for manufacturing color filters of LCDs has created a need for inks that can be dispensed by an inkjet without clogging the inkjet, i.e., have good jettability, and that do not degrade during inkjetting. In particular, there is a need for inks that are physically and chemically stable before, during, and after inkjetting and that have a color chromaticity that meets color filter specifications for both computer and television monitors, as well as for other devices containing displays.

### SUMMARY OF THE INVENTION

In some aspects of the invention, a first composition of matter is provided. The first composition of matter is an ink for display device manufacturing. The ink includes (1) a first solvent having a first evaporation rate of about 0 to about 0.353; and (2) a second solvent having a second, different evaporation rate of about 0 to about 0.353 combined with the first solvent.

In other aspects of the invention, a first apparatus for display device manufacturing is provided. The first apparatus includes (1) an ink for display device manufacturing having (a) a first solvent having a first evaporation rate of about 0 to about 0.353; and (b) a second solvent having a second, different evaporation rate of about 0 to about 0.353 combined with the first solvent; and (2) an inkjet print head adapted to form and dispense a droplet of the ink into a pixel well of a substrate.

In yet other aspects of the invention, a method of manufacturing an ink is provided. The method includes the steps of (1) providing a first solvent having a first evaporation rate of about 0 to about 0.353; and (2) combining a second solvent having a second, different evaporation rate of about 0 to about 0.353 with the first solvent.

In still other aspects of the invention, a method of display device manufacturing is provided. The method includes the steps of (1) providing an ink including (a) a first solvent having a first evaporation rate of about 0 to about 0.353; and (b) a second solvent having a second, different evaporation rate of about 0 to about 0.353 combined with the first solvent; and (2) forming and dispensing at least one droplet of the ink from an inkjet print head into a pixel well of a substrate.

In yet other aspects of the invention, a solvent mixture is provided. The solvent mixture includes (1) a first solvent having a first evaporation rate of about 0 to about 0.353; and (2) a second solvent having a second, different evaporation rate of about 0 to about 0.353 combined with the first solvent. Numerous other aspects are provided, as are systems and apparatus in accordance with these other aspects of the invention.

Other features and aspects of the present invention will become more fully apparent from the following detailed description, the appended claims and the accompanying drawings.

### BRIEF DESCRIPTION OF THE FIGURES

FIG. 1 illustrates a method of manufacturing an improved ink in accordance with an embodiment of the present invention.

FIG. 2 is a graph illustrating a drying profile of the improved ink in accordance with an embodiment of the present invention.

FIG. 3 is a block diagram of an apparatus for display device manufacturing in accordance with an embodiment of the present invention.

FIG. 4 illustrates a method of display device manufacturing in accordance with an embodiment of the present invention.

FIG. 5 is a cross-sectional front view of a film formed on a substrate by dispensing the improved ink from an inkjet print head in accordance with an embodiment of the present invention.

### DETAILED DESCRIPTION

Ink used by existing display device manufacturing systems may include a solvent, such as xylene, one or more color pigments and/or dyes and one or more monomers and/or oligomers. The solvent included in such ink may have a high evaporation rate of about 0.77. The evaporation rate (n-BuAc=1) of the solvent may determine how quickly the ink dries. For example, the higher the evaporation rate of the solvent, the faster the ink dries. Therefore, the ink used by existing display device manufacturing systems may dry too quickly. Such quick drying may adversely affect inkjetting reliability during display device manufacturing. For example, the high solvent evaporation rate of the ink may cause the ink to become viscous enough that droplets of ink of a desired size cannot be dispensed from the inkjet print head when desired and/or more than one droplet of ink may be inadvertently dispensed from the inkjet print head. Additionally or alternatively, the high solvent evaporation rate may repeatedly cause ink to dry onto one or more nozzles of the inkjet print head such that the nozzles may become clogged or otherwise obstructed. Consequently, the inkjet print head may require frequent cleaning which affects throughput of the printing system.

Further, the surface tension of ink employed by existing display device manufacturing systems may be 26.5 to 27.2. Due to such low ink surface tension, droplets formed from such ink may not be of an ideal shape (e.g., spherical). Accordingly, improved inks for display device manufacturing and methods of manufacturing and using the same are desired.

The present invention provides improved inks for display device manufacturing and methods of manufacturing and using the same. The inks of the present invention may include both extended drying times and higher surface tensions achieved through the use of solvent components that have multiple, slower evaporation rates and higher surface tensions. More specifically for example, the present invention may provide an ink including a plurality of solvents, each solvent having different respective evaporation rates (n-BuAc=1). For example, the ink may include at least Ethyl Cinnamate having an evaporation rate of less than about 0.001 and pentyl propionate having an evaporation rate of about 0.18. Such an ink may provide improved inkjetting reliability (compared to ink employed by existing display device manufacturing systems). For example, ink including such solvents does not become too viscous too quickly. To wit, the ink remains viscous enough that droplets of ink of a desired size may be dispensed from the inkjet print head when desired. Additionally or alternatively, the ink remains viscous enough such that a plurality of small ink droplets are not inadvertently dispensed from the inkjet print head instead of a single ink drop. Further, the above-described combination of solvents in the ink prevents the ink from drying onto one or more nozzles of an inkjet print head thereby avoiding the nozzles becoming clogged or otherwise obstructed. Therefore, such solvent combination may increase an idle time before the inkjet print head is required to be cleaned.

Additionally, in some embodiments, the improved ink may have a surface tension of greater than about 27.2 to about 30. Due to such surface tension, droplets formed from such ink may have an improved shape compared to droplets formed from ink used by existing display device manufacturing systems. For example, droplets formed from the improved ink may be closer to an ideal shape (e.g., spherical) than droplets formed from existing inks. Further, a profile of film formed by depositing the improved ink into a pixel well of the substrate may be improved (e.g., flatter) than a film formed using existing inks. For example, a film formed using the improved ink of the present invention may have a more consistent relative thickness across a cross-section compared to a similar film formed using ink employed by existing display device manufacturing systems. In this manner, the present invention provides improved ink compositions for display device manufacturing and methods of manufacturing and using the same.

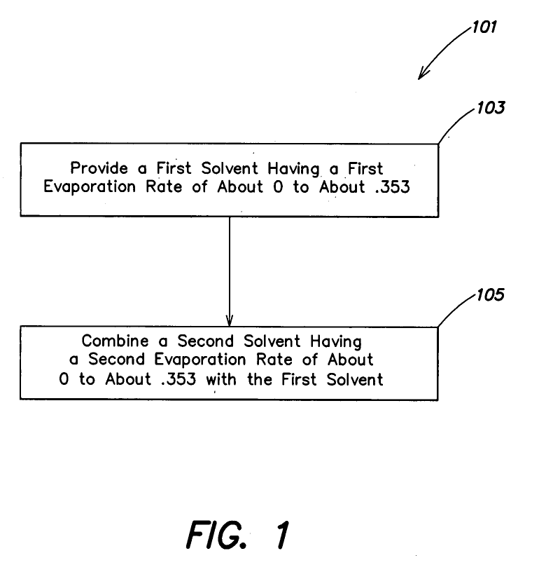

FIG. 1 illustrates an example method 101 of manufacturing an improved ink in accordance with an embodiment of the present invention. With reference to FIG. 1, in step 103, a first solvent having an evaporation rate of about 0 to about 0.353 may be provided. However, a larger or smaller and/or different evaporation rate range may be employed. The evaporation rate of the first solvent, in part, may determine how quickly the improved ink formed thereby dries. The first solvent may be Ethyl Cinnamate, Ethylene glycol methyl ether acetate, Coasal or pentyl propionate and/or one or more other suitable chemicals. The Ethyl Cinnamate may have a molecular weight of about 176, a surface tension of about 37.6 mN/m, an evaporation rate of less than about 0.001, and may form about 5% to about 30% of the improved ink (although a different molecular weight, surface tension and/or evaporation rate may be employed). Additionally or alternatively, the Ethyl Cinnamate may form a larger or smaller percentage of the improved ink.

The Ethylene glycol methyl ether acetate may have a molecular weight of about 118, a surface tension of about 34 mN/m, an evaporation rate of about 0.353, and may form about 5% to about 20% of the improved ink (although a different molecular weight, surface tension and/or evaporation rate may be employed). Additionally or alternatively, the Ethylene glycol methyl ether acetate may form a larger or smaller percentage of the improved ink.

The Coasal may have a surface tension of about 27.2 mN/m, an evaporation rate of about 0.001, and may form about 5% to about 15% of the improved ink. The Coasal may include a mixture of Di-isobutyl esters of adpic acid, glutaric acid and succinic acid (although Coasal may include a larger or smaller and/or different chemicals). A larger or smaller surface tension and/or evaporation rate may be employed. Additionally or alternatively, the Coasal may form a larger or smaller percentage of the improved ink.

The pentyl propionate may have a molecular weight of about 144, a surface tension of about 26.5 mN/m, an evaporation rate of less than about 0.18, and may form about 5% to about 30% of the improved ink (although a different molecular weight, surface tension and/or evaporation rate may be employed). Additionally or alternatively, the pentyl propionate may form a larger or smaller percentage of the improved ink.

In step 105, a second solvent having an evaporation rate of about 0 to about 0.353 may be combined with the first solvent. However, a larger or smaller and/or different evaporation rate range may be employed. The evaporation rate of the second solvent is different from that of the first solvent. The evaporation rate of the second solvent, in part, may determine how quickly the improved ink formed thereby dries. The second solvent may be combined with the first solvent via mixing and/or any other suitable method. The second solvent may include a remaining one of the Ethyl Cinnamate, Ethylene glycol methyl ether acetate, Coasal, pentyl propionate and/or other suitable chemicals (described above) which was not employed as the first solvent. In some embodiments, one or more of the solvents may be provided by a liquid supply cabinet.

The combination of the first and second solvents causes the surface tension of the ink to change by about 0.3 mN/meter to about 3.5 mN/meter compared to existing inks. The surface tension of the ink is changed, in part, based on the concentration of the solvents. The preferred amount of surface tension for jetting ink and filling ink wells is greater than about 27.2 to about 30.

In some embodiments, one or more additional solvents having different respective evaporation rates may be combined with the first and second solvents. For example, in some embodiments, an improved ink may include four different solvents, each having a different evaporation rate. The evaporation rates may be related, for example, in that the second solvent evaporates half as fast as the first solvent; the third solvent evaporates half as fast as the second solvent; and the forth solvent evaporates half as fast as the third solvent. This example combination of solvents may result in an ink that has a drying profile that begins to dry (e.g., increase viscosity) quickly but gradually slows down.

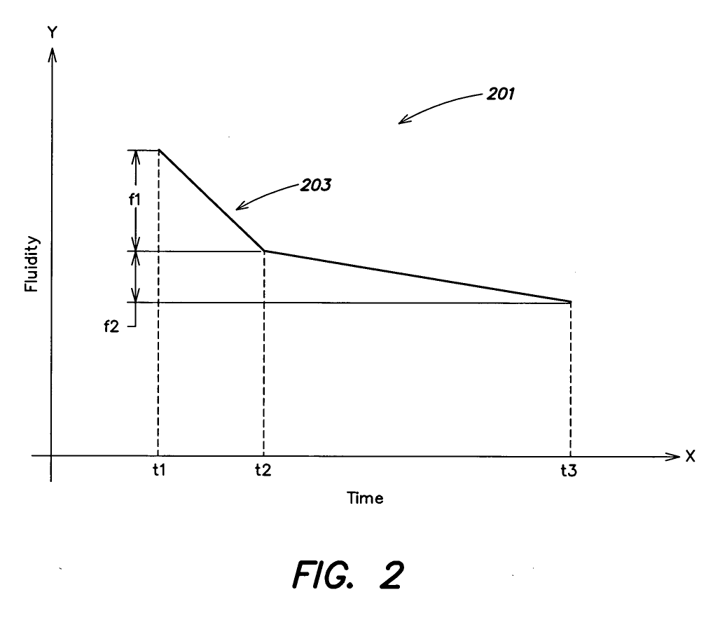

The improved ink of the present invention has desirable characteristics. For example, the jetting reliability of the improved ink is increased compared to that provided by an existing ink (e.g., ink employed by existing display device manufacturing systems). More specifically, the combination of the first and second solvents may affect the drying profile of the ink (e.g., the rate at which the improved ink dries). Details of the improved ink drying profile are described below with reference to FIG. 2. The drying profile of the improved ink enables the ink to remain viscous enough such that one or more ink droplets of a desired size and/or shape may be dispensed from an inkjet print head when desired. For example, the ink may retain a viscosity such that, when attempting to dispense a single droplet of the improved ink from the inkjet print head during display device manufacturing, a spherical or approximately spherical droplet of the improved ink is dispensed. Thus, the combination of the first and second solvents may prevent the improved ink from becoming so viscous that, when attempting to dispense a single droplet from the inkjet print head, the single droplet cannot be dispensed, more than one droplet is inadvertently dispensed and/or a droplet having a non-ideal shape (e.g., a droplet that is not spherical or approximately spherical, a teardrop shape, etc.) is dispensed.

Additionally or alternatively, the ink of the present invention improves ink drop quality. More specifically, the combination of the first and second solvents may cause the surface tension of the improved ink to be about 27.2 to about 30. However, a larger or smaller and/or different surface tension range may be employed. The surface tension of the improved ink may cause droplets formed from the improved ink to have an ideal (e.g., spherical) or approximately ideal shape. The surface tension of the improved ink may be increased compared to that of ink employed by existing display device manufacturing systems. Therefore, the shape of a droplet formed from the improved ink is closer to ideal that a droplet formed from existing inks. Additionally or alternatively, the ink may remain viscous enough to repeatedly dispense droplets having approximately the same size. For example, the diameter variation of droplets of the improved ink dispensed from an inkjet print head may be about 1% for at least 95% of such droplets. 1However, a larger or smaller percentage may be employed for the diameter variation and/or number of droplets.

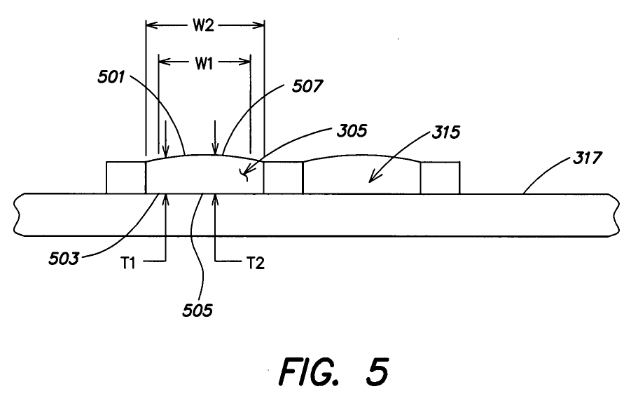

Further, a cross-sectional profile of film formed on the substrate using the improved ink may be enhanced (e.g., more uniform) compared to the profile of a film formed on a substrate using an existing ink. Details of the film profile formed by dispensing the improved ink on a substrate are described below with reference to FIG. 5.

In some embodiments, at least one color pigment or dye, at least one monomer and/or at least one oligomer may be combined with the first and second solvents to form the ink. Additionally or alternatively, at least one initiator (e.g., photoinitiator) may be combined with the first and second solvents to form the ink.

Thereafter, the method 101 ends. Through use of the present method 101, an ink that improves jetting reliability may be manufactured.

FIG. 2 is a graph 201 illustrating a drying profile 203 of the improved ink in accordance with an embodiment of the present invention. With reference to FIG. 2, the graph 201 illustrates the fluidity of the improved ink over time. The respective evaporation rates of the first and second solvents cause the improved ink to exhibit such a drying profile 203. For example, the evaporation rate of the first solvent, which is higher than that of the second solvent, may cause the improved ink to dry at a first rate over a first time period (e.g., between times t1 and t2) of about less than 1 second. Therefore, the fluidity of the improved ink may change a first amount f1 over the first time period. Further, the evaporation rate of the second solvent may cause the improved ink to dry at a second, slower rate over a second time period (e.g., between times t2 and t3 of about greater than ten minutes. Although a larger or smaller first and/or second time period may be employed. Therefore, the fluidity of the improved ink may change a second, smaller amount f2 over the second time period. Consequently, the result of mixing solvents with different evaporation rates in the manner described above is that once the improved ink is jetted at time t1, the ink may become more viscous to a point (e.g., to time t2) due to and based on the evaporation rate (e.g., a high rate) of the first solvent. Thereafter, the improved ink may continue to dry, but more slowly, based on the lower evaporation rate (e.g., a low rate) of the second solvent.

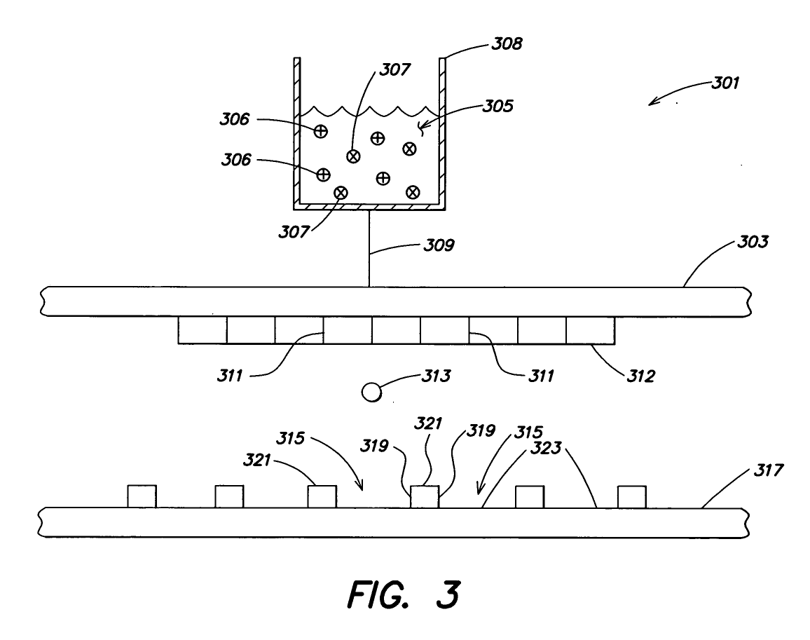

FIG. 3 is a block diagram of an apparatus 301 for display device manufacturing in accordance with an embodiment of the present invention. With reference to FIG. 3, the apparatus 301 may include an inkjet print head 303 coupled to the improved ink 305 including first and second solvents 306, 307. For example, the apparatus 301 may include a reservoir or tank 308 adapted to store the improved ink 305. The inkjet print head 303 may be coupled to the reservoir or tank 307 via a supply line 309 adapted to provide the improved ink 305 to the inkjet print head 303 as desired.

The inkjet print head 303 may include one or more nozzles 311 (defined by a nozzle plate 312) from which one or more droplets 313 of the improved ink 305 may be dispensed into a pixel well 315 of a substrate 317. Sidewalls 319 of the pixel well 315 may be defined by a black matrix 321, and a bottom 323 of the pixel well 315 may be defined by the substrate 317. As described above, the improved ink 305 may cause droplets 313 formed thereof to be spherical or approximately spherical in shape.

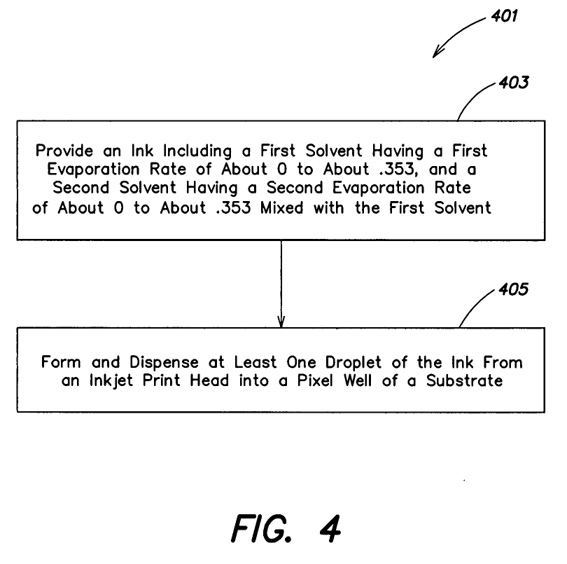

Operation of the apparatus 301 is now described with reference to FIG. 4 which illustrates a method 401 of display device manufacturing in accordance with an embodiment of the present invention. With reference to FIG. 4, in step 403, an ink, which includes a first solvent having a first evaporation rate of about 0 to about 0.353 and a second solvent having a second evaporation rate of about 0 to about 0.353 combined with the first solvent, may be provided. In some embodiments, the ink may include one or more additional solvents having different respective evaporation rates combined with the first and second solvents.

In step 405, at least one droplet 313 of the ink 305 may be formed by and dispensed from the inkjet print head 303 into the pixel well 315 of the substrate 317. As described above, such an ink 305 has desirable characteristics. For example, the ink 305 may provide improved jetting reliability. Respective evaporation rates of the first and second ink solvents 306, 307 may affect the surface tension and/or drying profile 203 of the ink 305 such that one or more ink droplets 313 of a desired size and/or shape may be dispensed from an inkjet print head 303 when desired. More specifically, the first and second solvents 306, 307 may cause a surface tension of the ink 305 to be increased compared to that of an ink employed by existing display device manufacturing systems. Therefore, the shape of one or more droplets of the ink 305 formed by and dispensed from a nozzle 311 of the inkjet print head 303 may be closer to an ideal shape than that of a droplet formed from an existing ink. For example, the inkjet print head 303 may form and dispense at least one spherical or approximately spherical droplet 313 of the ink 305 therefrom. In this manner, the inkjet print head 303 may repeatedly and consistently form and dispense spherical or approximately spherical droplets 313 of the ink 305.

Additionally or alternatively, the above-described drying profile 203 of the ink 305 enables the ink 305 to remain viscous enough such that, when attempting to dispense a single droplet 313 of the ink 305 from the inkjet print head 303 during display device manufacturing, a single spherical or approximately spherical droplet 313 of the ink 305 is dispensed. Thus, the combination of the first and second solvents 306, 307 may prevent the improved ink 305 from becoming so viscous that, when attempting to dispense a single droplet 313 from the inkjet print head 303, the single droplet 303 cannot be dispensed.

Additionally or alternatively, the combination of the first and second solvents 306, 307 in the ink 305 may prevent the ink 305 from becoming so viscous that, when attempting to dispense a single droplet 313 from the inkjet print head 303, more than one droplet 313 is inadvertently dispensed. Additionally or alternatively, the combination of the first and second solvents 306, 307 may prevent the ink 305 from becoming so viscous that, when attempting to dispense a single droplet 313 from the inkjet print head 303, one or more droplets having a non-ideal shape (e.g., oval) are dispensed.

Additionally or alternatively, the combination of the first and second solvents 306, 307 in the ink 305 enables the ink 305 to remain viscous enough such that the inkjet print head 303 may repeatedly dispense droplets 313 having approximately the same size. For example, the diameter variation of droplets 313 of the improved ink 305 dispensed from an inkjet print head 303 may be about 1% for at least 95% of such droplets 313. Consequently, the above-described combination of solvents 306, 307 in the ink 305 may prevent the ink 305 from drying onto one or more nozzles 311 of the inkjet print head 313 such that the nozzles 311 become clogged or otherwise obstructed. Thus, such inkjet print head 313 may not have to be taken offline for cleaning as often. Consequently, the ink 305 may improve a throughput of the printing system.

Thereafter, the method 401 ends. Through use of the present method 401, ink 305 may be jetted into pixel wells 315 of a substrate 317 with improved reliability. For example, a consistency with which ink droplets 313 are dispensed from an inkjet print head 303 when desired may be improved. Additionally or alternatively, a quality of ink droplets dispensed from the inkjet print head 303 may be improved. More specifically, consistency of droplet shape and/or size may be improved. Further, in some embodiments, a profile of a film formed on the substrate 317 using the improved ink 305 may be enhanced compared to the profile of a film formed on a substrate using an existing ink. Details of the film formed by dispensing the ink 305 on the substrate 317 are described below with reference to FIG. 5.

FIG. 5 is a cross-sectional front view of a film 501 formed on a substrate 317 by dispensing the improved ink 305 from an inkjet print head (303 in FIG. 3) in accordance with an embodiment of the present invention. With reference to FIG. 5, characteristics of the ink 305, such as the drying profile (203 in FIG. 2) and surface tension, may cause a film 501 formed by dispensing ink 305 from the inkjet print head (303 in FIG. 3) into a pixel well 315 of a substrate 317 to be more uniform and/or flatter than a similar film formed using an existing ink. As described above, the first and second solvents 306, 307 may cause the ink 305 to have such desirable characteristics. Consequently, over a width W1 of the film 305, which represents a portion of an overall width W2 of the film 305, the thinnest portion 503 of the film 305 over such width W1 may have a thickness T1 and the thickest portion 505 of the film 305 over such width W1 may have a thickness T2. The thickness variation between T1 and T2 may be about less than about 1%. However, a larger or smaller percentage may be employed for the thickness variation. Further, a larger or smaller and/or different percentage range may be employed for the width. In this manner, the film 501 formed by the ink 305 may have a flatter and/or more uniform profile 507 than that of a similar film formed using an existing ink.

The following non-limiting examples are provided to further illustrate the embodiments of the invention. However, the examples are not intended to be all inclusive and are not intended to limit the scope of the invention described herein. A first exemplary improved ink in accordance with an embodiment of the present invention may include pentyl propionate, ethyl cinnamate and coasal. About 30% of the improved ink is pentyl propionate, about 7.5% of the improved ink is ethyl cinnamate and about 7.5% of the improved ink is coasal. Therefore, the ratio of ethyl cinnamate to coasal to pentyl propionate is 1:1:4. Alternatively, a second exemplary improved ink in accordance with an embodiment of the present invention may include pentyl propionate, ethylene glycol methyl ether acetate and coasal. About 30% of the improved ink is pentyl propionate, about 13% of the improved ink is ethylene glycol methyl ether acetate and about 15% of the improved ink is coasal. Therefore, the ratio of ethylene glycol methyl ether acetate to coasal to pentyl propionate is 13:15:30.

As described above, the Ethyl Cinnamate may have a molecular weight of about 176, a surface tension of about 37.6 mN/m, and an evaporation rate of less than about 0.001. The Ethylene glycol methyl ether acetate may have a molecular weight of about 118, a surface tension of about 34 mN/m, and an evaporation rate of about 0.353. The Coasal may have a surface tension of about 27.2 mN/m, and an evaporation rate of about 0.001. The pentyl propionate may have a molecular weight of about 144, a surface tension of about 26.5 mN/m, and an evaporation rate of less than about 0.18.

The foregoing description discloses only exemplary embodiments of the invention. Modifications of the above disclosed apparatus and methods which fall within the scope of the invention will be readily apparent to those of ordinary skill in the art. For instance, as described above, combining a plurality of solvents 306, 307 having different respective evaporation rates to form an ink 305 may improve ink jetting reliability. For example, a desired number of droplets may be dispensed from an inkjet print head nozzle 311 when desired. Further, as described above, combining such solvents 306, 307 may improve droplet quality. For example, the solvents 306, 307 may cause a shape and/or size of ink droplets (and consistency thereof) to improve. Further, as described above, combining such solvents 306, 307 to form an ink 305 may cause a film 501 formed thereby to have an improved profile 507. Additionally, in some embodiments, the solvent combination (along with other additives) may improve pigment dispersion in the ink 305. Further, the solvent combination may also prevent premature curing of the ink 305.

Accordingly, while the present invention has been disclosed in connection with exemplary embodiments thereof, it should be understood that other embodiments may fall within the spirit and scope of the invention, as defined by the following claims.

The invention claimed is:

1. An ink for display device manufacturing, comprising:
a first solvent having a first evaporation rate of about 0 to about 0.353; and
a second solvent having a second, different evaporation rate of about 0 to about 0.353 combined with the first solvent.

2. The ink of claim 1 further comprising one or more of:
at least one color pigment or dye;
at least one monomer;
at least one oligomer; and
at least one initiator.

3. The ink of claim 1 wherein the first and second solvents cause the ink to have a surface tension of greater than about 27.2 to about 30.

4. The ink of claim 3 wherein the first and second solvents cause droplets formed from the ink to be spherical or approximately spherical.

5. The ink of claim 1 wherein the first and second solvents cause the ink to dry at a first rate over a first time period of about 1 second and to dry at a second, slower rate over a second time period of greater than about ten minutes.

6. The ink of claim 1 wherein the first and second solvents cause the ink to remain viscous enough such that, when attempting to dispense a single droplet of the ink from an inkjet print head during display device manufacturing, a spherical or approximately spherical droplet of the ink is dispensed.

7. The ink of claim 1 wherein the first and second solvents cause the ink to remain viscous enough such that, when attempting to dispense a single droplet of the ink from an inkjet print head during display device manufacturing, a plurality of droplets of the ink are not dispensed.

8. The ink of claim 1 wherein the first and second solvents cause a film formed by the ink on a pixel well of a substrate to have a thickness variation of less than about 1%.

9. The ink of claim 1 wherein the first and second solvents cause a diameter variation of about 1% for at least 95% of droplets of the ink dispensed from an inkjet print head.

10. An apparatus for display device manufacturing, comprising:
ink for display device manufacturing including:
a first solvent having a first evaporation rate of about 0 to about 0.353; and
a second solvent having a second, different evaporation rate of about 0 to about 0.353 combined with the first solvent; and
an inkjet print head adapted to form and dispense at least one droplet of the ink into a pixel well of a substrate.

11. The apparatus of claim 10 wherein the ink further comprises one or more of:
at least one color pigment or dye;
at least one monomer;
at least one oligomer; and
at least one initiator.

12. The apparatus of claim 10 wherein the first and second solvents of the ink cause the ink to have a surface tension of greater than about 27.2 to about 30.

13. The apparatus of claim 12 wherein the first and second solvents cause the at least one droplet formed from the ink to be spherical or approximately spherical.

14. The apparatus of claim 10 wherein the first and second solvents cause the ink to dry at a first rate over a first time period of about 1 second and to dry at a second, slower rate over a second time period of greater than about ten minutes.

15. The apparatus of claim 10 wherein the first and second solvents cause the ink to remain viscous enough such that, when attempting to dispense a single droplet of the ink from the inkjet print head during display device manufacturing, a single spherical or approximately spherical droplet of the ink is dispensed.

16. The apparatus of claim 10 wherein the first and second solvents cause the ink to remain viscous enough such that, when attempting to dispense a single droplet of the ink from the inkjet print head during display device manufacturing, a plurality of droplets of the ink are not dispensed.

17. The apparatus of claim 10 wherein the first and second solvents cause a film formed by dispensing ink from the inkjet print head into the pixel well of the substrate to have a thickness variation of less than about 1%.

18. The apparatus of claim 10 wherein the first and second solvents cause a diameter variation of about 1% for at least 95% of droplets of the ink dispensed from the inkjet print head.

19. A method of manufacturing an ink, comprising:
providing a first solvent having a first evaporation rate of about 0 to about 0.353; and
combining a second solvent having a second, different evaporation rate of about 0 to about 0.353 with the first solvent.

20. The method of claim 19 further comprising combining one or more of at least one color pigment or dye, at least one monomer, at least one oligomer and at least one initiator with the first and second solvents.

21. A method of display device manufacturing, comprising:
providing an ink including:
a first solvent having a first evaporation rate of about 0 to about 0.353; and
a second solvent having a second, different evaporation rate of about 0 to about 0.353 combined with the first solvent; and
forming and dispensing at least one droplet of the ink from an inkjet print head into a pixel well of a substrate.

22. The method of claim 21 wherein:
the ink has a surface tension of greater than about 27.2 to about 30; and
forming and dispensing at least one droplet of the ink includes forming and dispensing a spherical or approximately spherical droplet of the ink.

23. The method of claim 21 further comprising employing the first and second solvents to cause the ink to dry at a first rate over a first time period of about 1 second and to dry at a second, slower rate over a second time period of greater than about ten minutes.

24. The method of claim 21 further comprising employing the first and second solvents to cause the ink to remain viscous enough such that, when attempting to dispense a single droplet of the ink from the inkjet print head during display device manufacturing, a spherical or approximately spherical droplet of the ink is dispensed.

25. The method of claim 21 further comprising employing the first and second solvents to cause the ink to remain viscous enough such that, when attempting to dispense a single droplet of the ink from the inkjet print head during display device manufacturing, a plurality of droplets of the ink are not dispensed.

26. The method of claim 21 further comprising employing the ink to form a film in the pixel well of the substrate having a thickness variation of about 1%.

27. The method of claim 21 wherein:
forming and dispensing at least one droplet of the ink includes forming and dispensing a plurality of droplets of the ink; and
a diameter variation for at least 95% of the plurality of droplets is of about 1%.

28. The ink of claim 1 further comprising a third solvent having a third evaporation rate of about 0 to about 0.353;
wherein the first solvent is pentyl propionate and forms about 30% of the ink;
wherein the second solvent is ethyl cinnamate and forms about 7.5% of the ink; and
wherein the third solvent is coasal and forms about 7.5% of the ink.

29. The ink of claim 1 further comprising a third solvent having a third evaporation rate of about 0 to about 0.353;
wherein the first solvent is pentyl propionate and forms about 30% of the ink;
wherein the second solvent is ethylene glycol methyl ether acetate and forms about 13% of the ink; and
wherein the third solvent is coasal and forms about 15% of the ink.

30. A solvent mixture, comprising:
a first solvent having a first evaporation rate of about 0 to about 0.353; and
a second solvent having a second, different evaporation rate of about 0 to about 0.353 combined with the first solvent.

31. The solvent mixture of claim 30 wherein the first and second solvents cause the ink to have a surface tension of greater than about 27.2 to about 30.

32. The solvent mixture of claim 31 wherein the first and second solvents cause droplets formed from the ink to be spherical or approximately spherical.

33. The solvent mixture of claim 30 wherein the first and second solvents cause the ink to dry at a first rate over a first time period of about 1 second and to dry at a second, slower rate over a second time period of greater than about ten minutes.

34. The solvent mixture of claim 30 wherein the first and second solvents cause the ink to remain viscous enough such that, when attempting to dispense a single droplet of the ink from an inkjet print head during display device manufacturing, a spherical or approximately spherical droplet of the ink is dispensed.

35. The solvent mixture of claim 30 wherein the first and second solvents cause the ink to remain viscous enough such that, when attempting to dispense a single droplet of the ink from an inkjet print head during display device manufacturing, a plurality of droplets of the ink are not dispensed.

36. The solvent mixture of claim 30 wherein the first and second solvents cause a film formed by the ink on a pixel well of a substrate to have a thickness variation of less than about 1%.

37. The solvent mixture of claim 30 wherein the first and second solvents cause a diameter variation of about 1% for at least 95% of droplets of the ink dispensed from an inkjet print head.
